(19) United States
(12) Patent Application Publication
(10) Pub. No.: US 2008/0046010 A1
(43) Pub. Date: Feb. 21, 2008

(54) Pacifier device

(76) Inventors: Daniel J. Wood, Stafford, VA (US); Katrina V. Wood, Stafford, VA (US)

Correspondence Address: KLIMA LAW OFFICES, P.L.L.C., P.O. Box 2855, Stafford, VA, 22555-2855, US

(21) Appl. No.: 11/504,052

(22) Filed: Aug. 15, 2006

(51) Int. Cl. A61J 17/00

(52) U.S. Cl. 606/234

(57) ABSTRACT

A pacifier device including a pacifier portion connected to a strap portion, preferably a resilient strap portion. The pacifier device allows the child to grab and manipulate the pacifier device without aid or assistance.

### FIELD OF THE INVENTION

The present invention is directed to a pacifier device, in particular a pacifier device for use by an infant or toddler.

### BACKGROUND OF THE INVENTION

Most infants and some toddlers are administered a pacifier by their mother, father or other caregiver to sooth the child. The typical pacifier includes a latex rubber nipple similar to a mother's natural nipple that allows the child to gum or eventually teeth the nipple. There exist many prior art pacifiers having various configurations or arrangements.

The pacifier device according to the present invention provides an improved pacifier device with advantages over the prior art pacifiers.

### SUMMARY OF THE INVENTION

An object of the present invention is to provide an improved pacifier device.

A second object of the present invention is to provide a pacifier device including a pacifier connected to a strap.

A third object of the present invention is to provide a pacifier device including a pacifier releaseably connected to a strap.

A fourth object of the present invention is to provide a pacifier device with a pacifier permanently or substantially permanently connected to a strap.

A fifth object of the present invention is to provide a pacifier device including a resilient strap having a through hole configured to accommodate a pacifier therein.

A sixth object of the present invention is to provide a pacifier device including a resilient strap having a reinforced through hole for accommodating a pacifier.

A seventh object of the present invention is to provide a pacifier device including a resilient strap having a through hole configured to accommodate a pacifier, said through hole having a diameter less than a diameter of the pacifier.

A eighth object of the present invention is to provide a pacifier device including a resilient strap having a through hole configured to accommodate and provide an interference connection with a pacifier.

The present invention is directed to a pacifier device. The pacifier device includes a pacifier portion in combination with a strap portion, preferably a resilient strap portion.

A preferred embodiment of the pacifier device according to the present invention includes a separate pacifier portion releaseably connected to a strap portion, preferably a resilient strap portion. Another preferred embodiment of the present invention includes a separate pacifier portion permanently or substantially permanently connected to a strap portion, preferably a resilient strap portion.

A preferred embodiment of the pacifier device according to the present invention includes a strap portion, preferably an elongated strap portion. The strap portion is preferably long enough to extend and wrap around the child's head over the cheeks and ears of the child when in use. The ends of the strap portion are then available for the child to grip with his or her hands to grab the pacifier device and move or manipulate the pacifier device into position in the child's mouth, even unassisted. Further, the ends of the strap portion allow the child to play or otherwise manipulate the ends when the child is using the pacifier device providing an added use feature.

The strap portion can be made of fabric, cloth, plastic, film, composite, felt, terry cloth or other suitable material. Preferably, the strap portion is made of a soft and resilient fabric or cloth material. The strap portion can be made of a single layer of material or can be made of multiple layers (e.g. two layers, three layers, or more). In one preferred embodiment, an elastic fabric layer is sewn (e.g. around its perimeter and/or lines of interior stitches) to a soft layer to be placed in contact with the child's mouth and skin during use.

In a preferred embodiment of the pacifier device according to the present invention, a through hole is provided in the strap portion. The through hole is preferably centered along the length of the strap portion so that the strap ends are of the same length. Further, the through hole is also preferably centered along the width of the strap portion to provide enough strap material around the through hole to adequately secure the pacifier portion to the strap portion. In a most preferred embodiment of the pacifier device according to the present invention, the through hole is reinforced so as to strengthen the through hole to enhance connection with the pacifier to prevent tearing of or damage to the through hole, to prevent fraying of fabric material around the through hole, and to otherwise make the through hole durable for long lasting use of the pacifier device. In this preferred embodiment, the strap portion is reusable and the pacifier portion can be changed or replaced as needed.

The through hole of the strap portion can be reinforced in various ways. For example, the through hole through a fabric strap portion can be reinforced by sewing around the edge or adjacent to the edge of the through hole. The thread can be sewn through the thickness of the strap portion in one or more concentric rings and/or sewn so as to be aligned radially inwardly around the edge of the through hole and looped over the edge thereof. Alternatively, an adhesive can be applied to the exposed edge of the through hole and/or around the perimeter of the through hole to reinforce the through hole. As a further alternative, a plastic insert (e.g. plastic washer or grommet) can be applied to one or both sides of the strap adjacent or surrounding the through hole and heat welded or otherwise bonded to the fabric material to reinforce same. Further, a latex layer can be applied to the edge and/or around the perimeter of the through hole again to reinforce same.

In a preferred embodiment, an interference connection is provided between the pacifier and the through hole of the strap portion. For example, the diameter of the through hole is less than the diameter of the pacifier portion at the point of connection of the pacifier portion with the strap portion. The pacifier portion can be provided with a groove for accommodating the edges of the through hole of the strap portion. In this arrangement, the bottom edge of the groove of the pacifier portion has a diameter greater than the diameter of the through hole to provide an interference fit. Preferably, the interference fit provides for a band stress to be applied from the fabric material surrounding the through hole against the pacifier portion to firmly secure the edge of the through hole of the strap portion within the groove of pacifier. In this embodiment, the through hole will stretch open to a wider diameter to accommodate the pacifier portion to provide a good connection therebetween. Alternatively, the through hole of the fabric material can be reinforced so as to resist stretching, however, the pacifier portion is sufficiently resilient so as to resiliently deform to a smaller diameter when positioned within the through hole so that the pacifier portion exerts an outwardly directed radial force against the inner edge of the through hole again securing the pacifier portion to the strap portion.

The through hole of the fabric strap portion can be reinforced with resilient thread to allow the through hole to stretch to a wider diameter in one embodiment, or can be sewn with a non-resilient thread so as to prevent the through hole from stretching open. In any event, it is preferred that an interference connection is provided between the pacifier portion and the strap portion so that the pacifier is securely held within the strap portion during use or non-use to prevent disconnection therebetween.

In another preferred embodiment, the pacifier portion is permanently or substantially permanently connected to the strap portion. For example, the pacifier portion can be secured to the strap portion by sewing, adhesive, heat welding, bonding, combination of methods again to securely connect the pacifier portion to the strap portion. This embodiment allows the entire pacifier device to be washed and reused, for example, in a clothes washer or dish washer..

In another embodiment of the pacifier device according to the present invention, the ends of the strap portion are weighted so that the pacifier device wraps around the child's head and stays in position during use. The strap ends can be weighted by use of a weight fastened or enclosed within the ends of the strap portion. For example, weighted pellets, plates, washers, strips or other suitable weights can be applied, connected or enclosed at or near the ends of the strap portion.

### BRIEF DESCRIPTION OF THE DRAWINGS

FIG. 1 is a perspective view of a preferred embodiment of the pacifier device according to the present invention.

FIG. 2 is a side elevational view of the pacifier device shown in FIG. 1.

FIG. 3 is a bottom planar view of the pacifier device shown in FIG. 1.

FIG. 4 is a top planar view of the strap portion only of the pacifier device shown in FIG. 1 with the pacifier portion removed.

FIG. 5 is a broken away partial side elevational view of the pacifier portion of the pacifier device shown in FIG. 1.

FIG. 6A is a broken away partial side elevational view of another embodiment of the strap portion having two layers.

FIG. 6B is a broken away partial side eleveation view of a further embodiment of the strap portion having three layers of material.

FIG. 7 is a top planar view of another preferred embodiment of the pacifier device according to the present invention.

FIG. 8 is a side elevational view of the pacifier device shown in FIG. 7.

FIG. 9 is a further preferred embodiment of the pacifier device according to the present invention including a strap portion having weighted ends.

FIG. 10 is a front elevational view of a child's head with the pacifier device shown in FIG. 1 in use.

FIG. 11 is a side elevational view of a child's head with the pacifier device shown in FIG. 1 in use.

### DETAIL DESCRIPTION OF PREFERRED EMBODIMENTS

A preferred embodiment of the pacifier device 10 according to the present inventions is shown in FIGS. 1-5.

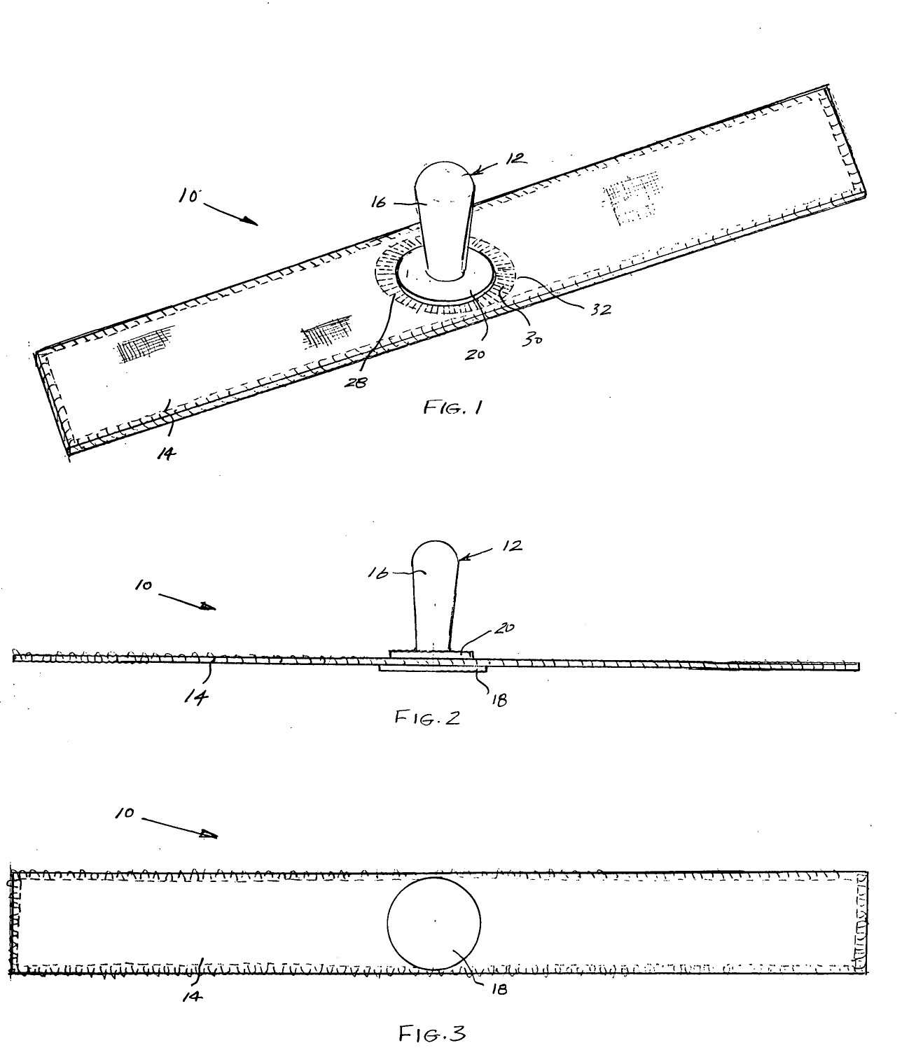

The pacifier device 10 includes a pacifier portion 12 removably connected to a strap portion 14. The pacifier portion 12 includes a nipple portion 16 connected to a base portion 18 (See FIG. 2). The pacifier portion 12 includes an outwardly extending radial protrusion portion 20 located between the nipple portion 16 and base portion 18, as shown in FIG. 2. The protrusion portion 20 is located above the strap portion 14, and the base portion 18 is located below the strap portion 14 to provide a securement with the strap portion 14. Specifically, the base portion 18 and ring-shaped protrusion portion 20, as shown in FIG. 5, define a groove 22 for accommodating the edge of the through hole 24 in the strap portion 14, as shown in FIG. 4. The details of this connection will be further described below.

The pacifier portion 12 is preferably a one-piece resilient latex molded pacifier unit. The nipple portion 16 is preferably hollow to provide softening thereof. The base portion 18 is preferably a round base portion and the protrusion 20 is preferably a round protrusion similar to a washer radially extending outwardly. Again the entire structure of the pacifier portion 12 is preferably molded as a single piece from latex material having the shape and configuration shown. Again, the protrusion 20 and base portion 18 define the groove 22 for receiving the edge 26 of the through hole 24.

The edge 26 of the through hole 24 in the strap portion 14 is preferably reinforced by a ring-shaped sewn portion 28 positioned adjacent and surrounding the through hole 24, shown in FIG. 4. Specifically, thread 30 is stitched to penetrate the strap 14 and around the edge 26 of the through hole 24 to reinforce the upper surface, lower surface and exposed inner side edge 26 located around the perimeter of the through hole 24. The threads 30 are radially aligned to extend from the edge 26 radially outwardly and end at an outer boundary or edge 32. The thread 30 is preferably a resilient or elastic thread so that the inner side edge 26 is reinforced while still allowing the through hole 24 to be stretched to a greater diameter during insertion and assembly of the pacifier device 10.

The pacifier portion 12 can be connected to the strap portion 14 by inserting the nipple portion 16 through the through hole 24 of the strap portion 14, and then pulling the pacifier portion 12 through the through hole 24 until the strap portion makes contact with the protrusion 20 of the pacifier 12. The through hole 24 of the strap 14 is stretched open and worked around the outer edge of the protrusion 20 until the inner side edge 26 enters into the groove 22 of the pacifier portion 12. The through hole 24 is released so that the strap material disposed within the groove 22 applies a band stress within groove 22 of the pacifier portion 12. The diameter of through hole 24 can be stretched larger than the outer diameter of the protrusion 20 of the pacifier device 12 to allow assembly of the pacifier device 10.

As shown in FIGS. 4 and 5, the diameter Dₛ of the through hole 24 in the strap portion 14 is less than the diameter D_{P} of the groove 22 in the pacifier portion 12. This provides for a band stress connection between the pacifier portion 12 and strap portion 14 after assembly providing a secure connection therebetween.

The strap portion 14 can be made from a wide variety of materials including fabric, stretchable fabric material, cloth, elastic, felt, plastic, fiber, composite, quilting, terry cloth, flannel, cotton, polyester, knit, yarn, or other suitable material. The strap portion 14 is preferably configured as an elongated member having a suitable length so as to at least partially wrap around a child's head, as shown in FIGS. 10 and 11. Preferably the through hole 24 is provided in the center of the strap portion 14, however, other locations may be suitable. A single layer of material can be utilized to make the strap portion 14. For example, a terry cloth material can be cut to size and shape and then the edges are surged to finish and secure the edges around the perimeter thereof. A hole can be cut to provide the through hole 24, and again the inner side edge 26 of the through hole 24 can be surged to finish and secure the inner side edge 26.

The pacifier portion 12 is removably connected to the strap portion 12 in the embodiment shown in FIG. 1. However, the pacifier portion 12 can be permanently or substantially permanently connect to the strap portion after assembly by adhesive, heat welding, sewing, thread, mechanical fastener, snap fastener or other suitable fastening method.

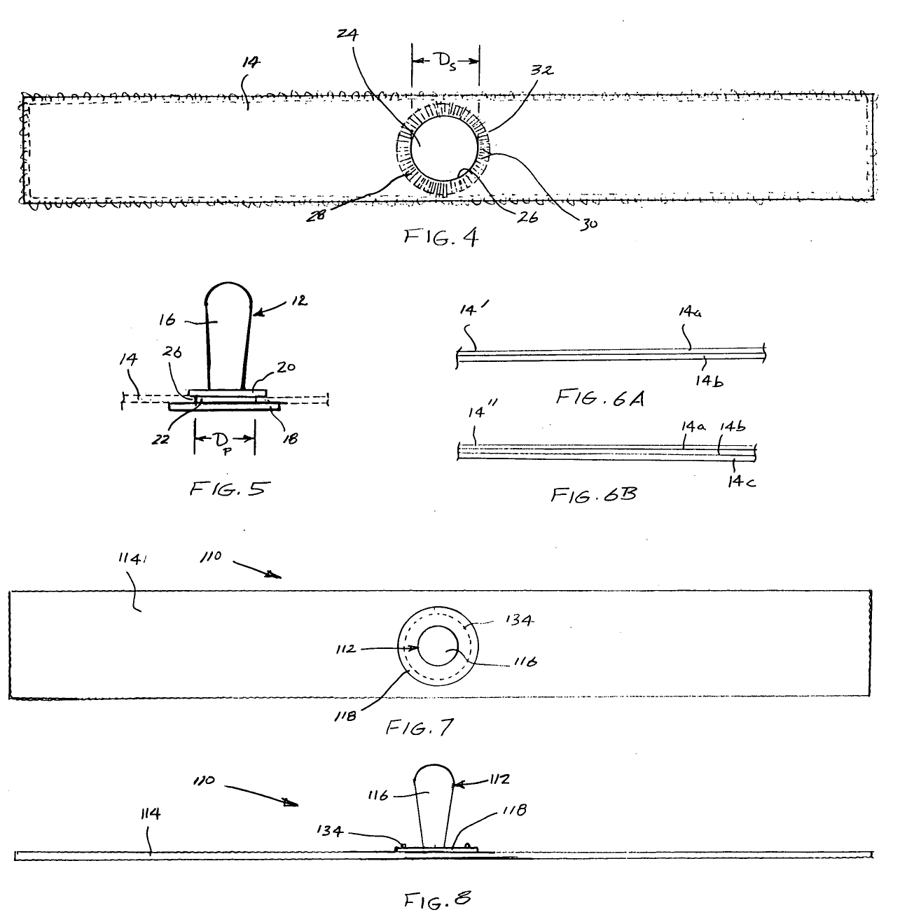

In other embodiments, two (2) layers of material 14a, 14b as shown in FIG. 6A are combined to form the strap portion 14′. For example, layer 14a can be an elastic fabric material (e.g. Spandex) and the lower layer 14b can be a terry cloth layer sewn together. In a further embodiment, the strap portion 14″ is made of three (3) separate layers 14a, 14b, 14c, as shown in FIG. 6B. For example, the upper layer 14a and the lower layer 14c can be made of a soft fabric material (e.g. terry cloth or flannel) and the inner layer 14b is made of an elastic material with all layers sewn together to make a strap unit.

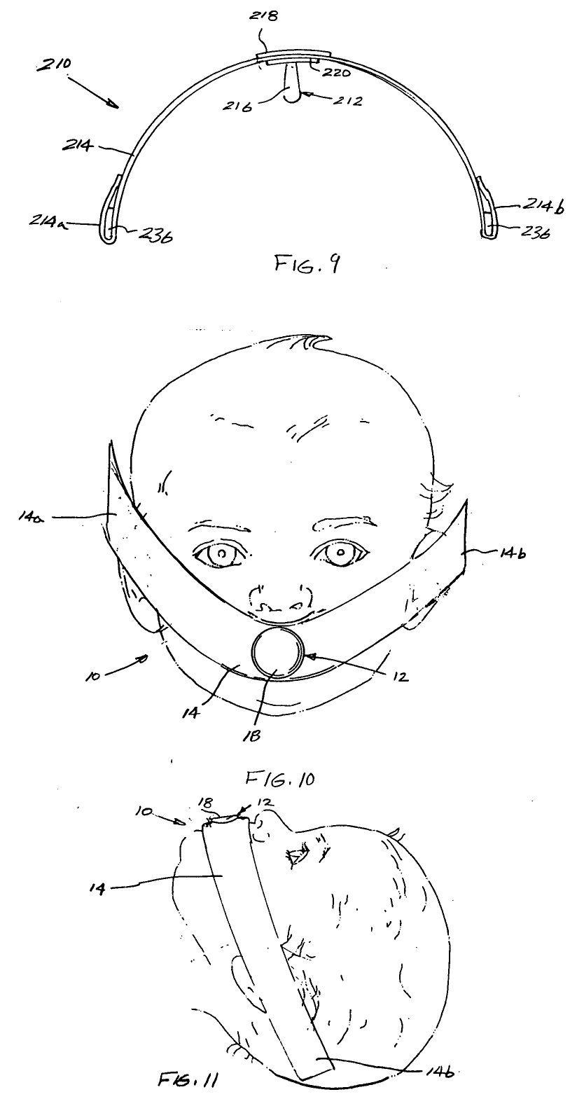

A further preferred embodiment of the pacifier device 110 according to the present invention is shown in FIGS. 7 and 8.

In this embodiment, the pacifier portion 112 is permanently or substantially permanently attached to the strap portion 114. For example, the pacifier portion 112 includes a nipple portion 116 and a base portion 118. The base portion 118 is sewn by threads 134 through the base portion 118 and through the strap portion 114 to secure the pacifier portion 112 to the strap portion 114.

An even further preferred embodiment of the pacifier device 214 according to the present invention is shown in FIG. 9.

The pacifier device 214 is essentially the same as the embodiment shown in FIG. 1, however, the ends 214a, 214b of the strap portion 214 are weighted. For example, weights 236 are added to the ends 214a, 214b, of the strap portion 214. The ends of the strap 214 are folded over the weights 236 and sewn together to enclose, capture or otherwise secure the weights 236 within the ends 214a, 214b of the strap portion 214.

During use, the pacifier device 10 wraps around the head of the child as shown in FIGS. 10 and 1 1. The flexible nature of the strap portion 14 allows the strap portion 14 to bend and conform to the shape of the child's head. The pacifier 12 is inserted into the mouth of the child securing the pacifier device 10 to the child's head. The strap ends 14a, 14b stabilize the strap portion 14 on the child's head without requiring any fasteners or other securements. Further the strap ends 14a, 14b allow the child to grab the pacifier device 10 for positioning the pacifier 12 in the child's mouth or repositioning of the pacifier device 10. Further, the strap ends 14a, 14b provide a gripping item for play or manipulation by the child's hand.

I claim:

1. A pacifier device, comprising:
a one-piece resilient molded latex pacifier portion including a nipple portion connected to and extending to a round base plate portion, said pacifier including a ring-shaped protrusion portion extending radial outwardly and located between said nipple portion and said base portion defining an annular circular groove between said protrusion portion and said base plate portion in said pacifier portion; and
a flat elongated resilient strap portion connected to said pacifier, said strap portion made of a stretchable fabric, said strap portion including a round centered through hole configured to accommodate said pacifier portion, said strap portion including a resilient reinforced inner side edge surrounding said through hole cooperating with and disposed within said circular groove of said pacifier to securely and elastically connect said pacifier to said strap, said inner side edge reinforced by thread sewn through said strap adjacent said edge and looped around an exposed face of said edge, said pacifier portion and said through hole of said strap sized so that said through hole is stretched to a larger diameter when said pacifier portion is mounted within said through hole of said strap portion after assembly of said pacifier portion and said strap portion.

2. A pacifier device, comprising:
a pacifier portion including a nipple portion and a round base portion, said pacifier portion including a ring-shaped protrusion extending radial outwardly located between said nipple portion and said base portion defining an annular circular groove in said pacifier portion; and
a resilient flat strap portion connected to said pacifier portion, said strap portion including a through hole configured to accommodate said pacifier portion, said strap portion including a resilient reinforced inner side edge surrounding said through hole, said reinforced inner side edge cooperating with and disposed within said circular groove of said pacifier portion to securely connect said pacifier portion to said strap portion, said pacifier portion and said strap portion configured so that an edge of said through hole of said strap exerts a band stress on a surface of said groove of said pacifier portion when said pacifier portion is installed within said through hole of said strap portion to secure said pacifier portion to said strap portion.

3. A pacifier device, comprising:
a pacifier portion including a nipple portion and a round base portion, said pacifier portion including a circumferential groove; and
a resilient flat strap portion connected to said pacifier portion, said strap portion including a through hole configured to accommodate said pacifier portion, said strap portion including an edge surrounding said through hole cooperating with and disposed within said circular groove of said pacifier portion to securely connect said pacifier portion to said strap portion, said through hole having an inner diameter less than an outer diameter of an inner edge of said groove to provide an elastic interference connection between said pacifier portion and said strap portion.

4. A device according to claim 1, wherein an inner diameter of said through hole in said strap portion is less than an outer diameter of said groove in said pacifier portion prior to assembly of said pacifier portion and said strap portion.

5. A device according to claim 1, wherein an elastic interference connection is provided between said pacifier portion and said strap portion when said pacifier portion is installed within said through hole of said strap portion.

6. A device according to claim 1, wherein said strap portion is made of terry cloth.

7. A device according to claim 1, wherein said strap portion is made of a single layer of fabric material.

8. A device according to claim 1, wherein said strap portion is made of multiple layers of fabric material.

9. A device according to claim 8, wherein said strap portion is made of an upper elastic fabric layer and a lower soft cloth protective layer.

10. A device according to claim 1, wherein said through hole in said strap portion is centered in a length dimension of said strap portion.

11. A device according to claim 1, wherein said through hole in said strap portion is centered in a width dimension of said strap portion.

12. A device according to claim 1, wherein said through hole in said strap portion is centered in both length and width dimensions of said strap portion.

13. A device according to claim 1, wherein said thread is resilient thread.

14. A device according to claim 1, wherein said thread is a non-resilient thread.

15. A device according to claim 1, wherein said strap portion is made of fabric material having an outer side edge and a through hole, said outer edge and an inner side edge of said through hole being surged with thread to finish same.

16. A device according to claim 1, wherein said ring-shaped protrusion of said pacifier portion is sized and shaped to fit through said through hole in said strap portion during assembly.

17. A device according to claim 1, wherein an outer diameter of said base plate of said pacifier portion is larger than an outer diameter of said ring-shaped protrusion of said pacifier portion.

18. A device according to claim 16, wherein an outer diameter of said base plate of said pacifier portion is larger than an outer diameter of said ring-shaped protrusion of said pacifier portion.

19. A device according to claim 1, wherein ends of said strap portion are weight to facilitate said pacifier device being retained in position on a child's head.

20. A device according to claim 1, wherein said pacifier portion is permanently connected to said strap portion.
